(19) United States
(12) Patent Application Publication
(10) Pub. No.: US 2016/0026325 A1
(43) Pub. Date: Jan. 28, 2016

(54) HAND-HELD ELECTRONIC DEVICE, TOUCH-SENSING COVER AND COMPUTER-EXECUTED METHOD

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/748,797

(22) Filed: Jun. 24, 2015

(30) Foreign Application Priority Data
Jul. 25, 2014 (CN) 201410361454.1
Jul. 25, 2014 (CN) 201410361577.5
Jul. 25, 2014 (CN) 201410361684.8
Jul. 25, 2014 (CN) 201410361727.2
Jul. 25, 2014 (CN) 201410361729.1
Aug. 4, 2014 (CN) 201410380717.3

(51) Int. Cl. G06F 3/041; G06F 3/0484; G06F 1/16; G06F 3/0485

(52) U.S. Cl. CPC G06F 3/0416; G06F 3/0485; G06F 3/04845; G06F 1/1692

(57) ABSTRACT

A shadeless touch hand-held electronic device comprises a touch-sensing cover, a panel, and a control unit. The touch-sensing cover comprises a cover and a touch-sensing structure. Partial or total area of the touch-sensing structure is disposed on the cover and has a plurality of detection points. The control unit is electrically connected to the touch-sensing cover and the panel and executes following steps, the steps include: computing a trigger event of the detection points; comparing the trigger event with an initiative determination condition pre-stored in the shadeless touch hand-held electronic device; permitting the touch-sensing structure to receive at least one input action from a user if the trigger event conforms to the initiative determination condition; and executing the operation by the input action.

### CROSS REFERENCE TO RELATED APPLICATIONS

This Non-provisional application claims priority under 35 U.S.C. §119(a) on Patent Application No(s). 201410361684.8, 201410361727.2, 201410361577.5, 201410361729.1, 201410361454.1 filed in People's Republic of China on Jul. 25, 2014 and Patent Application No(s) 201410380717.3 filed in People's Republic of China on Aug. 4, 2014, the entire contents of which are hereby incorporated by reference.

### BACKGROUND OF THE INVENTION

1. Field of Invention

The invention relates to a hand-held electronic device, a touch-sensing cover and a computer-executed method, in particular, to a shadeless touch hand-held electronic device, a touch-sensing cover and a computer-executed method.

2. Related Art

With the advance of the technology, various novel digital devices are invented, such as cell phones, tablet computers, ultrabooks, GPS (Global Positioning System) navigation devices, etc. In addition to conventional input or control manners by keyboard or mouse, utilizing the touch-control technique to operate the digital device is a straight and popular operative manner. The touch display device has a friendly and intuitive straight input operation interface, and therefore users of all ages can manipulate the touch display device by fingers or a stylus.

As to the common and conventional hand-held electronic device with the touch function, the touch operations are almost directly executed on the display panel. However, for the operation on the panel, fingers will shade the user's view or the software object displayed on the display panel, such that the user may erroneously touch and open an undesired link arranged in a high information content density on the display panel by user's finger. To avoid the above situation, some hand-held electronic devices adopt a design where the touch operation zone is separated from the display panel, such as disclosed by the U.S. Pat. No. 5,825,352 (Logitech).

However, such design will enlarge the size of electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the problem of that user's view is easily shaded by user's finger in the operation of the hand-held electronic device.

In addition, because a user needs to contact the touch panel with fingers or stylus to control or operate the electronic device, it often scratches the panel. Besides, when operating well-known hand-held electronic device with touch control function, it usually requires one hand to hold the hand-held electronic device and the other hand to execute operation on the panel. If using just one hand to hold and operate the device, only the user's thumb can manipulate the device and it is really inconvenient.

Therefore, an aspect of the invention is to provide a shadeless touch hand-held electronic device, a touch-sensing cover and a computer-executed method which can avoid the user's view from being shaded by finger during the operation and reduce the scratch on the panel and enhance the convenience of the single-hand operation.

### SUMMARY OF THE INVENTION

An aspect of the invention is to provide a shadeless touch hand-held electronic device, a touch-sensing cover, and a computer-executed method, which avoids the user's view from being shaded by finger during the operation and reduces the scratch on the panel and enhances the convenience of one hand operation.

A shadeless touch hand-held electronic device comprises a touch-sensing cover, a panel, and a control unit. The touch-sensing cover comprises a cover and a touch-sensing structure. Partial or total area of the touch-sensing structure is disposed on the cover and has a plurality of detection points. The control unit is electrically connected to the touch-sensing cover and the panel and executes following steps, the steps comprises: computing a trigger event of the detection points; comparing the trigger event with an initiative determination condition pre-stored in the shadeless touch hand-held electronic device; permitting the touch-sensing structure to receive at least one input action from a user if the trigger event conforms to the initiative determination condition; and executing the operation by the input action.

In one embodiment, the trigger event comprises a trigger quantity, a trigger quantity distribution, a trigger morphology (which can refer to trigger appearance), a trigger time, a trigger frequency or a trigger location (which can refer to trigger position).

In one embodiment, the operation comprises a screen scrolling in one dimension, a screen rotation, a screen enlargement or a screen shrinking correspondingly on the panel.

In one embodiment, the screen scrolling in one dimension comprises a horizontal scrolling and a vertical scrolling.

In one embodiment, the operation comprises that the electronic data displayed on the panel is in response to the input action. The panel displays the response electronic data. The electronic data continues in response to the input action and displays a blank block exceeding the edge of the electronic data if the response electronic data reaches the edge of the electronic data and the input action is still detected. The electronic data is reversely moved until the blank block is not displayed if the blank block is detected and at least one of the input actions is no longer detected.

In one embodiment, the formats of electronic data comprise a webpage, an image, a text document, a table, an e-mail or an interface of multimedia player.

In one embodiment, the control unit computes the trigger event of the detection points with an interval in a predefined time period.

In one embodiment, the touch-sensing structure comprises metal mesh, metal nanowires, transparent conducting film, carbon nanotube or graphene.

In one embodiment, the touch-sensing cover is disposed on the side of the shadeless touch hand-held electronic device opposite the panel.

In one embodiment, the shadeless touch hand-held electronic device further comprises a wireless communication module, the wireless communication module comprises a wireless communication chip and an antenna, the wireless communication chip is electrically connected to the control unit, and the antenna is disposed on the cover or the touch-sensing structure.

In one embodiment, the user operates the hand-held electronic device by one hand, and takes the touch-sensing cover to face a light source or takes the back of the panel to face the light source.

In one embodiment, a circuit board, a battery or a memory card is disposed between the touch-sensing cover and the panel.

In one embodiment, the area of the touch-sensing structure and the area of the panel have a ratio relationship, and the control unit converts an input position into a display position on the panel according to the ratio relationship, and the panel shows a visible sign at the display position.

In one embodiment, the touch-sensing structure comprises a first sensing layer and a second sensing layer, and at least a part of the first sensing layer or the second sensing layer is capable of a wireless power transmission.

A computer-executed method is applied to a shadeless touch hand-held electronic device which has a touch-sensing cover, a panel and a control unit. The method executed on the shadeless touch hand-held electronic device comprises following steps of: computing a trigger event of a plurality of detection points of the touch-sensing cover; comparing the trigger event with an initiative determination condition pre-stored in the shadeless touch hand-held electronic device; permitting the touch-sensing cover to receive at least one input action from a user if the trigger event conforms to the initiative determination condition; and executing the operation by the input action.

In one embodiment, the trigger event comprises a trigger quantity, a trigger quantity distribution, a trigger morphology (which can refer to trigger appearance), a trigger time, a trigger frequency or a trigger location (which can refer to trigger position).

In one embodiment, the operation comprises a screen scrolling in one dimension, a screen rotation, a screen enlargement or a screen shrinking correspondingly on the panel.

In one embodiment, the operation comprises that the electronic data displayed on the panel is in response to the input action. The panel displays the response electronic data. The electronic data continues in response to the input action and displays a blank block exceeding the edge of the electronic data if the response electronic data reaches the edge of the electronic data and the input action is still detected. The electronic data is reversely moved until the blank block is not displayed if the blank block is detected and at least one of the input actions is no longer detected.

In one embodiment, the blank block comprises a black block, a grey block, a white block, or a blurred background block.

In one embodiment, the formats of electronic data comprise a webpage, an image, a text document, a table, an e-mail or an interface of multimedia player.

As mentioned above, as to the shadeless touch hand-held electronic device and touch-sensing cover, the user can perform the touch operation on the touch-sensing cover of the hand-held electronic device, so the user's finger will not shade the view or the object displayed on the panel, and the touch for opening the link of the high information density image will not erroneously execute. Besides, since operating the electronic device is performed on the touch-sensing cover, the panel scratch can be reduced. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can achieve a better user experience.

Furthermore, when the user uses the hand-held electronic device under the sun, he can hold the hand-held electronic device just by one hand and use the touch-sensing cover to block the sunlight or light source. Due to the panel information resulting from the touch-sensing cover which blocks the sunlight, the sunlight visibility of the panel is improved, and it can be implemented without advanced OLED or electric paper display panel technique. Furthermore, because the user can hold the device by one hand and perform the operation or input on the touch-sensing cover with respect to the information on the display panel, so as to enhance the single-hand operation performance of the shadeless touch hand-held electronic device under the strong light source.

In addition, the trigger quantity, the trigger quantity distribution, the trigger morphology (which can refer to trigger appearance), the trigger time, the trigger frequency or the trigger location (which can refer to trigger position) must firstly conform to the initiative determination condition, then the hand-held electronic device permits the touch-sensing cover to receive at least one input action from the user and accordingly execute a screen scrolling in one dimension, a 90 degree screen rotation, displaying virtual keyboard, a screen enlargement or a screen shrinking, etc. on the panel. Therefore, when other user operates the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security of the hand-held electronic device for information protection.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the shadeless touch hand-held electronic device according to the embodiment of the invention;

FIG. 2 is a schematic block diagram of the hand-held electronic device of FIG. 1;

FIG. 3 is a schematic diagram showing the hand-held electronic device of FIG. 1 at another viewing angle;

FIG. 4 is a flow chart showing the computer-executed method according to the embodiment of the invention;

FIG. 5 is a schematic diagram showing the detection points of the touch-sensing cover of FIG. 1 are triggered;

FIGS. 6A-6G are schematic diagrams showing different user interfaces of the hand-held electronic device of FIG. 1;

FIG. 7 is a flow chart showing the method for improving visibility of the display panel of the hand-held electronic device under the strong light according to the embodiment of the invention;

FIG. 8 is a schematic diagram showing the hand-held electronic device of FIG. 1 is used under the strong light;

FIG. 9 is a block diagram of the shadeless touch hand-held electronic device according to another embodiment of the invention;

FIG. 10 is a flow chart showing the computer-executed method according to the embodiment of the invention;

FIG. 11 is a schematic diagram showing the operation of the shadeless hand-held electronic device of FIG. 9;

FIG. 12 is an additional schematic diagram showing the operation of the shadeless hand-held electronic device of FIG. 9; and

FIG. 13 is an additional schematic diagram showing the operation of the shadeless hand-held electronic device of FIG. 9.

### DETAILED DESCRIPTION OF THE INVENTION

The present invention will be apparent from the following detailed description, which proceeds with reference to the accompanying drawings, wherein the same references relate to the same elements.

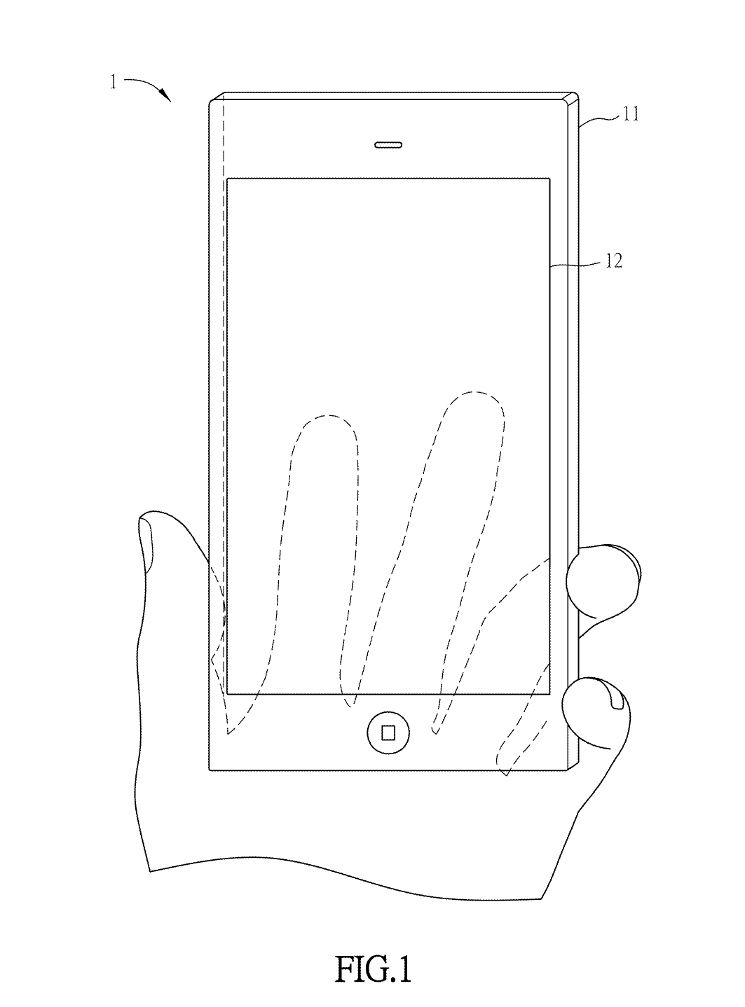

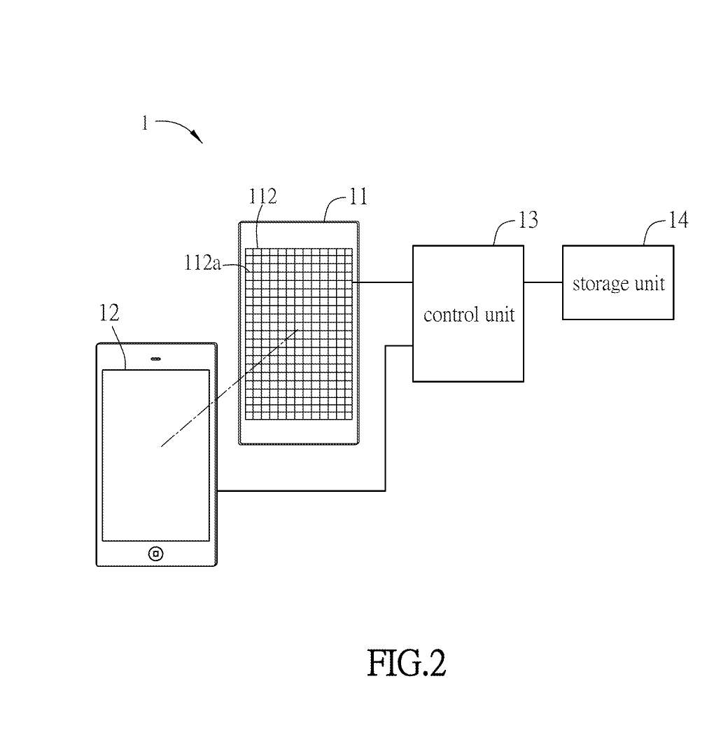

FIG. 1 is a schematic diagram showing the shadeless touch hand-held electronic device according to the embodiment of the invention. FIG. 2 is a schematic block diagram of the hand-held electronic device of FIG. 1. Referring to FIG. 1 and FIG. 2, the shadeless touch hand-held electronic device 1 (hereinafter abbreviated to hand-held electronic device 1) includes a touch-sensing cover 11, a panel 12, and a control unit 13. The panel 12 can include a display panel with display function or a touch display panel having display function and touch function as well. Additionally, the hand-held electronic device 1 can be a smart phone, a tablet computer, a personal digital assistant (PDA), etc, and it is a hand-held smart phone for example in the embodiment.

In the embodiment, the touch-sensing cover 11 is disposed on the side of the hand-held electronic device 1 opposite the panel 12. In other words, the touch-sensing cover 11 and the panel 12 respectively disposed on the two opposite sides of the hand-held electronic device 1, namely, respectively disposed on the front side and the back side of the hand-held electronic device 1. In the embodiment, the panel 12 is disposed on the front side of the hand-held electronic device 1, and the touch-sensing cover 11 is disposed on the back side thereof for example. The touch-sensing cover 11 and the panel 12 are respectively coupled to the control unit 13, so that the control unit 13 can control the content and the information displayed on the panel 12, and control the designate position on the touch-sensing cover 11 to be selected or input.

In detail, the touch-sensing cover 11 of the embodiment provides the human-machine interface between the electronic device and the user. The panel 12 can display for example a user interface (UI) such as a graphical user interface (GUI). Therefore, as shown in FIG. 1, the user can see the content displayed on the panel 12 from the front side of the hand-held electronic device 1 and perform the input operation on the touch-sensing cover 11 at the back side. In some embodiments, the hand-held electronic device 1 is accessible to be used in the strong light environment. The strong light environment includes the outdoor environment and the indoor environment. The light source of strong light environment includes sunlight or strong illumination lamp. As mentioned above, the hand-held electronic device 1 includes the touch-sensing cover 11 and the panel 12. The touch-sensing cover 11 is disposed on the side of the hand-held electronic device 1 opposite the panel 12, so the user can operate the hand-held electronic device 1 by one hand, and takes the touch-sensing cover 11 to face the light source of strong light environment and takes the panel 12 to face the user for blocking the sunlight or the strong light source. Because the back of the panel 12 faces the light source of the strong light environment, and due to the information displayed on the panel 12 benefiting from the touch-sensing cover 11 which blocks the sunlight, the sunlight visibility of the panel is improved. The user can perform the above operation or input or control on the touch-sensing cover 11 for the information displayed on the panel 12. Furthermore, the user can just hold by one hand and perform the input or control by the forefinger and the middle finger of the same hand. Therefore, the convenience while the user operates by one hand under the strong light (e.g. sunlight) can be enhanced. In comparison with the conventional art where just the thumb can be used in the single-hand operation, the operation on the touch-sensing cover 13 by the forefinger or middle finger can provide more flexibility and a novel user experience about the single-hand holding and multi-finger touch operation.

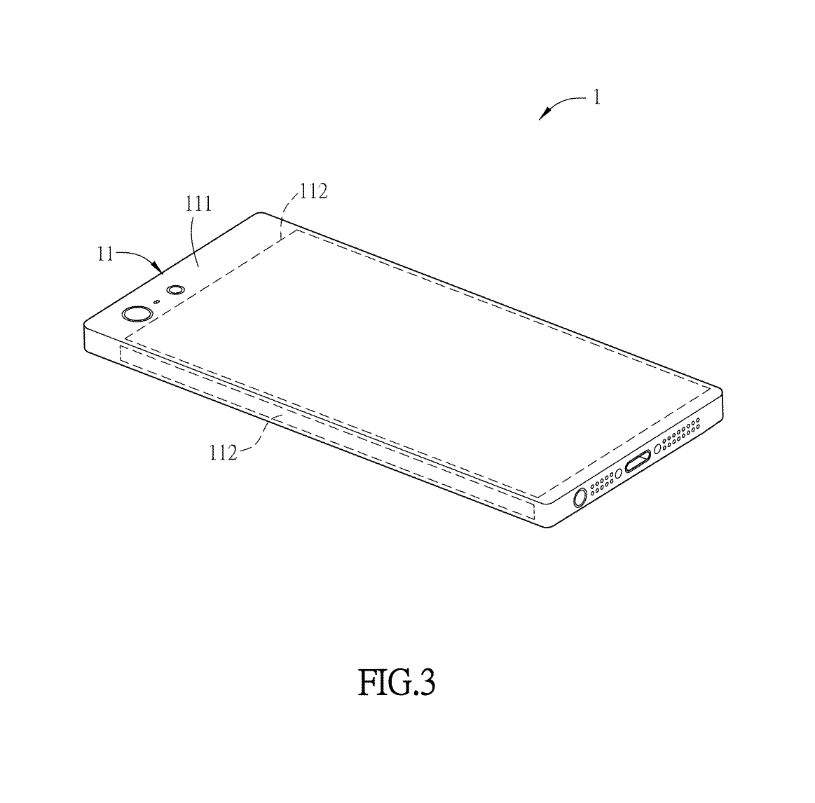

FIG. 3 is a schematic diagram showing the hand-held electronic device of FIG. 1 at another viewing angle. Referring to FIG. 3, the touch-sensing cover 11 includes a cover 111 and a touch-sensing structure 112. Similarly, the cover 111 is disposed on the side of the hand-held electronic device 1 opposite the panel 12 (the surface opposite the display surface). Partial or total area of the touch-sensing structure 112 can be disposed on the cover 111. In the embodiment, the touch-sensing structure 112 extends to the two sides of the cover 111, namely, extends to the two side edges of the touch-sensing cover 11 for increasing the area that the user can perform the operation. In other embodiments, other physical key can be replaced by the touch-sensing structure 112 of the embodiment, which is not limited thereto.

In addition, to utilize effectively the width of the touch-sensing cover 11 for disposing the touch-sensing structure 112, the width of the touch-sensing structure 112 can be slightly less than that of the touch-sensing cover 111 (e.g. about 5% to 10%), namely, the width of the touch-sensing structure 112 is about 90%˜95% of the width of the touch-sensing cover 11.

The touch-sensing structure 112 can be disposed on the inner surface of the cover 111 facing the panel 12 (inside the hand-held electronic device 1), or disposed on the outer surface of the cover 111 away from the panel 12 (outside the hand-held electronic device 1). The touch-sensing structure 112 of the embodiment is a capacitive touch structure and formed on the inner surface of the cover 111 facing the panel 12, and it is directly and fully formed on the cover 111 for example. In other embodiments, when the touch-sensing structure 112 is disposed on the outer surface of the cover 111 away from the panel 12, a protection layer is required for protecting the touch-sensing structure 112. It is noted that the material of the cover 111 can be glass, plastic, metal or other material, and the cover 111 is a part of the whole structure of the hand-held electronic device 1. In other words, the touch-sensing cover 11 is not an additional component (such as the protection cover of the electronic device). If the touch-sensing cover 11 is separated from the hand-held electronic device 1, the components inside the hand-held electronic device 1, such as battery or integrated circuit, etc., can be seen by the user. The touch-sensing structure 112 can further include a transmitter circuit and a receiver circuit (i.e. the so-called Tx and Rx, not shown), and the material thereof can comprise metal mesh, metal nanowires, transparent conducting film, carbon nanotube or graphene, but it is not limited thereto. Additionally, a circuit board, a battery or a memory card can be disposed between the touch-sensing cover 11 and the panel 12.

When the touch-sensing structure 112 is manufactured by the metal-mesh, the touch-sensing structure 112 can be disposed on the outer surface of the touch-sensing cover 11 (non-display surface), so that the metal texture effect can be exhibited on the appearance. Therefore, when the touch-sensing structure 112 constructed by the metal-mesh is disposed on the outer surface of the touch-sensing cover 11 of non-metallic (non-display surface), it can have an appearance with the metal texture effect. The metal cover (require more complicated process) is unnecessary and the cost can be further reduced.

In some embodiments, the wiring connecting to the touch-sensing structure 112 can be gathered to a single side for the wiring outlet and then electrically connected to a circuit board, so as to enhance the design flexibility.

In some embodiment, the touch-sensing structure 112 can also yield to the position of the camera lens or the flash of the touch-sensing cover 11, so there is no touch-sensing structure 112 allocated at a local region of the touch-sensing cover 11 (namely the position of the camera lens or the flash).

Besides, the touch-sensing structure 112 can be single-layer structure or double-layer structure. Taking the touch-sensing structure 112 is a double-layer structure for example. The touch-sensing structure 112 can include a first sensing layer and a second sensing layer to detect the input position on the touch-sensing structure 112 by the finger of the user. The first sensing layer includes a plurality of first sensing lines which are spaced along a first direction (direction X). The second sensing layer includes a plurality of second sensing lines which are spaced along a second direction (direction Y). Besides, in some embodiments, the first sensing layer and the second sensing layer are capable of wireless power transmission.

In other embodiment of the invention, for example, the touch-sensing structure may be a single-layer electrode structure. For example, the touch-sensing structure may include a plurality of sensing pads that are formed simultaneously, and the sensing pads may be in the form of a single layer structure. The sensing pads may be a transparent conductive layer or a metal mesh. The shape of the sensing pad includes, but not limited to, a triangle or a diamond shape, as long as they can help to achieve touch-sensing operations. Moreover, all sensing pads are not needed to have an identical shape.

Moreover, as shown in FIG. 2, the touch-sensing structure 112 has a plurality of detection points 112a and the detection points 112a can be triggered to act a trigger event. For example, when a conductor (for example but not limited to the stylus or user's hand, etc.) touches the touch-sensing structure 112, the detection points 112a located at the touch position can be triggered to generate the trigger signal corresponding to the trigger event. The trigger signal will be transmitted to the control unit 13 which can determine or analyze the trigger event. Thus, the trigger event can be generated corresponding to the holding position when the user holds the touch-sensing cover 11 by hand, or it is generated when the user perform the input action on the touch-sensing cover 11, but it is not limited thereto.

As to that the user performs the input action on the touch-sensing cover 11, it means that the user can utilize the touch-sensing cover 11 to operate the hand-held electronic device 1. As shown in FIG. 1, the panel 12 can display the corresponding action according to the posture (or called gesture) of the user thus operating the user interface displayed on the panel 12. For example, when the user's finger slides on the touch-sensing cover 11, the corresponding cursor (such as arrow or hand) displayed on the panel 12 can move correspondingly.

As mentioned above, the touch-sensing cover 11 and the panel 12 are respectively disposed on the two opposite sides of the hand-held electronic device 1 thus preventing user's hand from shading the display objects on the panel 12 and avoiding the erroneous touch operation when the user operates the hand-held electronic device 1. The method executed by the computer in the embodiment is applied to the shadeless touch hand-held electronic device 1. The method correspondingly executes the operation by the input action of user and it is implemented by the hand-held electronic device 1. The operation comprises screen scrolling in one dimension, a 90 degree screen rotation, displaying virtual keyboard, or a screen enlargement or a screen shrinking correspondingly on the panel 12.

In detail, as shown in FIG. 2, the hand-held electronic device 1 further comprises a storage unit 14, for example but not limited to a read-only memory (ROM), a random access memory (RAM), a flash memory, a field-programmable gate array (FPGA), or other memory. The storage unit 14 of the embodiment is RAM for example, and similarly it is coupled to the control unit 13 by signal bus.

In the embodiment, the storage unit 14 stores the operation system, application programs, data processing programs and electronic data of various formats, etc. The operation system is the program managing the hardware, firmware and software resources of computer. The application program can be a document processing program or an email program, etc. In the embodiment, data processing programs are the programs which detect the data structure of electronic data and generate corresponding link instructions. In the embodiment, the control unit 13 is a central processing unit (CPU) for example, and the control unit 13 executes these programs.

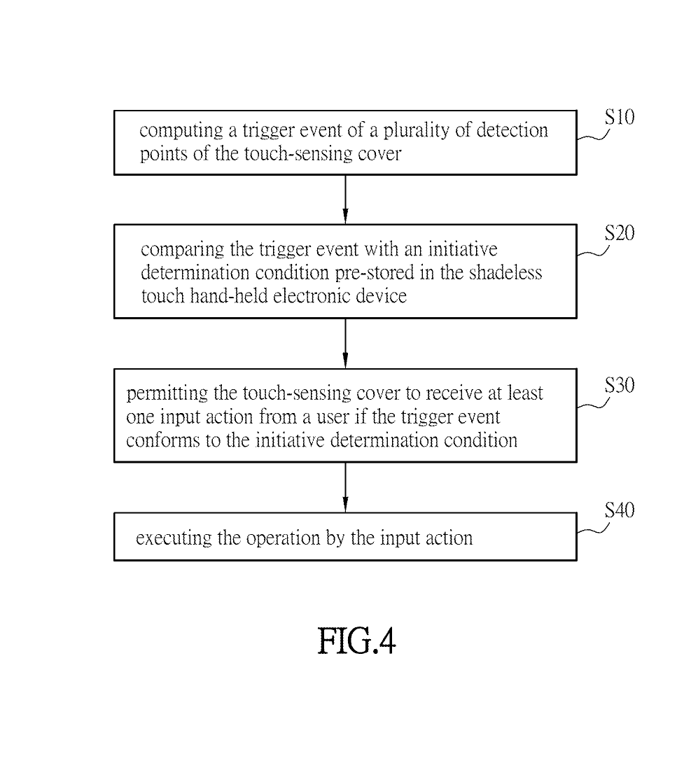

FIG. 4 is a flow chart showing the computer-executed method according to the embodiment of the invention. Referring to FIG. 4, the computer-executed method is applied to determine the input action from the gesture of the user and accordingly execute the operation. The method executed on the hand-held electronic device 1 includes: computing a trigger event of a plurality of detection points of the touch-sensing cover 11 (Step S10); comparing the trigger event with an initiative determination condition pre-stored in the shadeless touch hand-held electronic device (Step S20); permitting the touch-sensing cover to receive at least one input action from a user if the trigger event conforms to the initiative determination condition (Step S30); and executing the operation by the input action (Step S40).

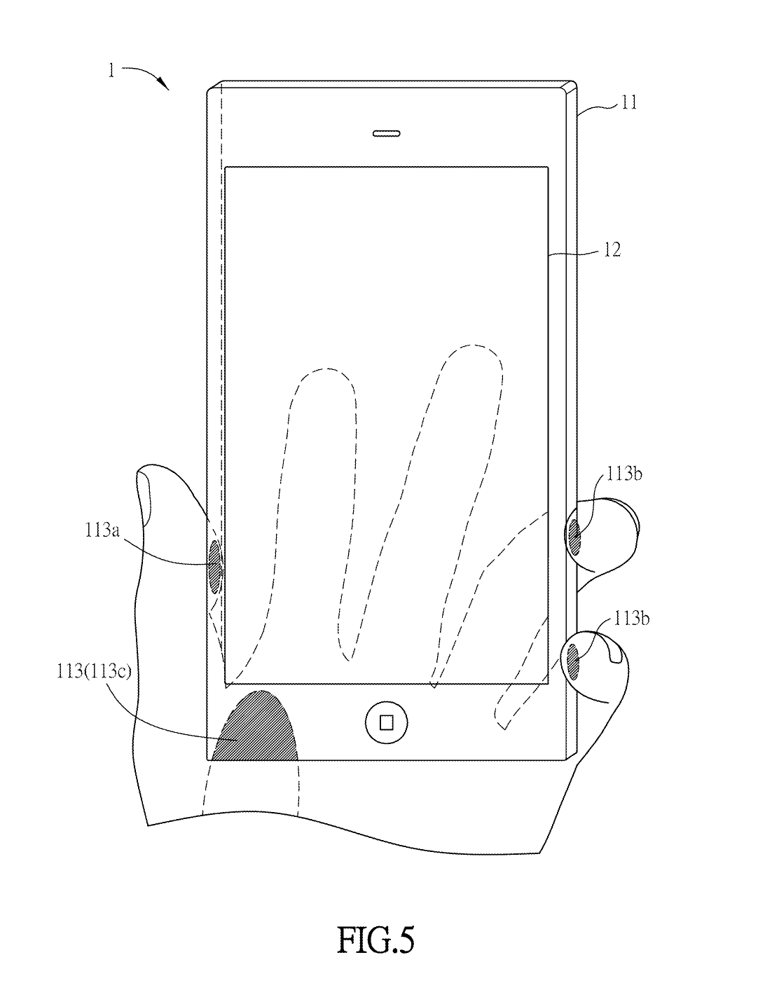

Referring to FIG. 1, FIG. 2 and FIG. 4, in Step S10, a part of the detection points 112a of the touch-sensing cover 11 are triggered. The user contacts the touch-sensing cover 11 and the detection points 112a which the touch-sensing cover 11 contacts are triggered to correspondingly generate a touch signal. Because the control unit 13 is coupled to the touch-sensing cover 11, the control unit 13 can receive the touch signal, and compute the trigger event of the triggered detection points 112a, namely, the trigger quantity, the trigger quantity distribution, the trigger morphology (which can refer to trigger appearance), the trigger time, the trigger location (which can refer to trigger position) or the trigger frequency. Referring to FIG. 5, FIG. 5 is a schematic diagram showing the detection points of the touch-sensing cover of FIG. 1 are triggered. In detail, when the user operates the hand-held electronic device 1, the holding habit of the user can be predefined, namely, the control unit 13 can analyze the trigger quantity, the trigger quantity distribution, the trigger morphology, the trigger time, the trigger location or the trigger frequency of the triggered detection points 112a which is triggered by the user on the operation setting interface, and define it as the initiative determination condition and save it in the storage unit 14. Namely, the holding position when the user operates the hand-held electronic device 1 is defined as the initiative determination condition. For example, the control unit 13 can analyze the positions of the triggered detection points 112a, and define the region where the number of the adjacent triggered detection point 112a is larger than a predetermined value as a trigger zone 113 (as shown in FIG. 5). The trigger morphology or the trigger quantity distribution of the detection points 112a in the embodiment is that one side of the touch-sensing cover 11 has a trigger zone 113a, another side has two trigger zones 113b, and the side of the touch-sensing cover 11 opposite the panel 12 has a trigger zone 113c. In other words in this embodiment, the trigger quantity distribution indicates the quantity of each trigger zone 113. The trigger morphology indicates the shape of each trigger zone 113, namely, the shapes of the trigger zones 113a, 113b, 113c. In other embodiment, the trigger time larger than a predetermined time can be defined as the initiative determination condition. Thus, if the trigger time is larger than the predetermined time, it is regarded as a valid input action. The trigger frequency can also be defined as the initiative determination condition, and the predetermined frequency can be regarded as password, which is similar to the concept of Morse code. If the trigger frequency conforms to the initiative determination condition, then the later input action are permitted to execute.

In the embodiment, after setting, when a conductor (e.g. user's hand) contacts the touch-sensing cover 11 and the control unit 13 receives the touch signal, the trigger event of the triggered detection points 112a can be computed as previously described (Step S10). The computed trigger event can be compared with the initiative determination condition pre-stored in the hand-held electronic device 1 (Step S20). As previously described, in the embodiment, the initiative determination condition is the user's holding position when the user operates the hand-held electronic device 1.

Then, if the trigger event conforms to the initiative determination condition, the touch-sensing structure 112 is permitted to receive at least one input action of user (Step S30). In other words, the trigger quantity, the trigger quantity distribution, the trigger morphology, the trigger time, the trigger frequency or the trigger location must firstly conform to the initiative determination condition, then the central processor 13 can execute other operation, namely, the input gesture of the user or other touch operation can be accepted. Therefore, if other user would like to operate the hand-held electronic device 1, he is forbidden to operate the hand-held electronic device 1 because the trigger event is distinct from the initiative determination condition predefined by the original user, and therefore the information security of the hand-held electronic device 1 can be enhanced. The control unit 13 can compute the trigger event of the detection points 112 with an interval in a predefined time period and compare it with the initiative determination condition for enhancing the using security of the hand-held electronic device 1.

When the user holds the hand-held electronic device 1 and the trigger event conforms to the initiative determination condition, the control unit 13 permits the touch-sensing structure 112 to receive the input action of user. Then, the control unit 13 executes step S40: executing the operation by the input action.

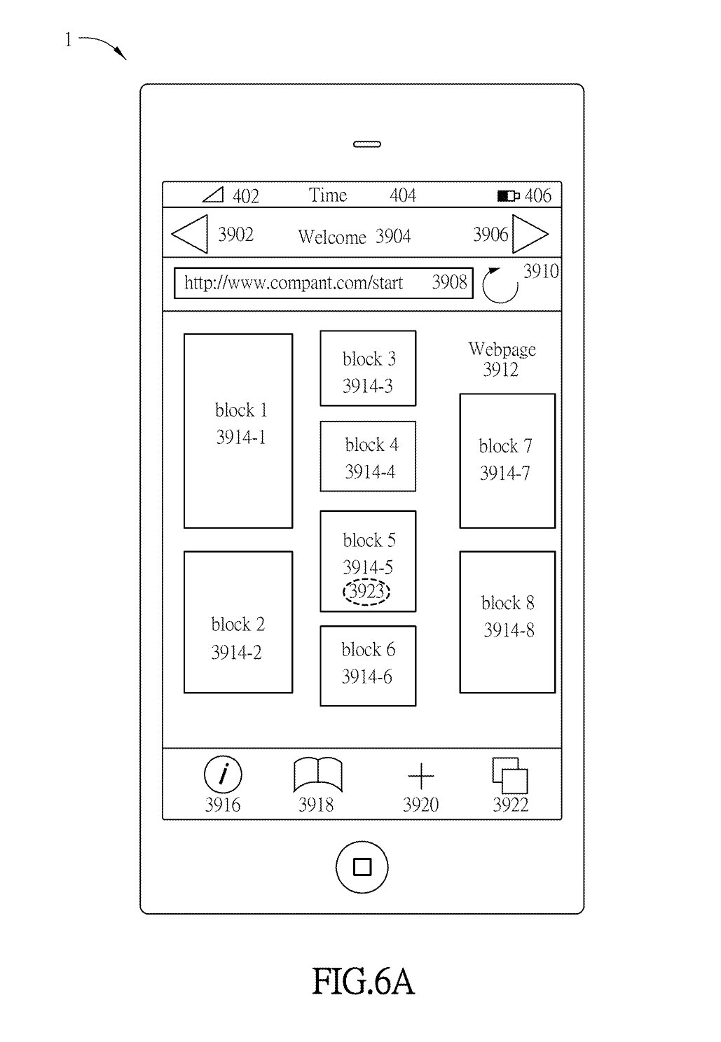

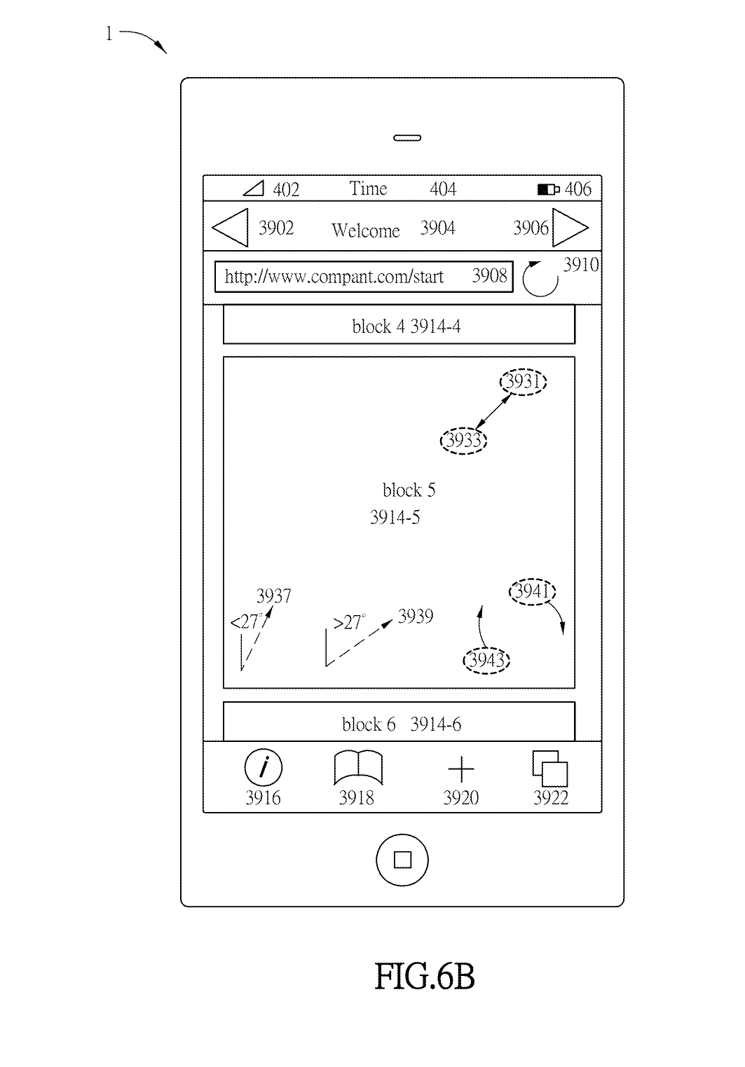

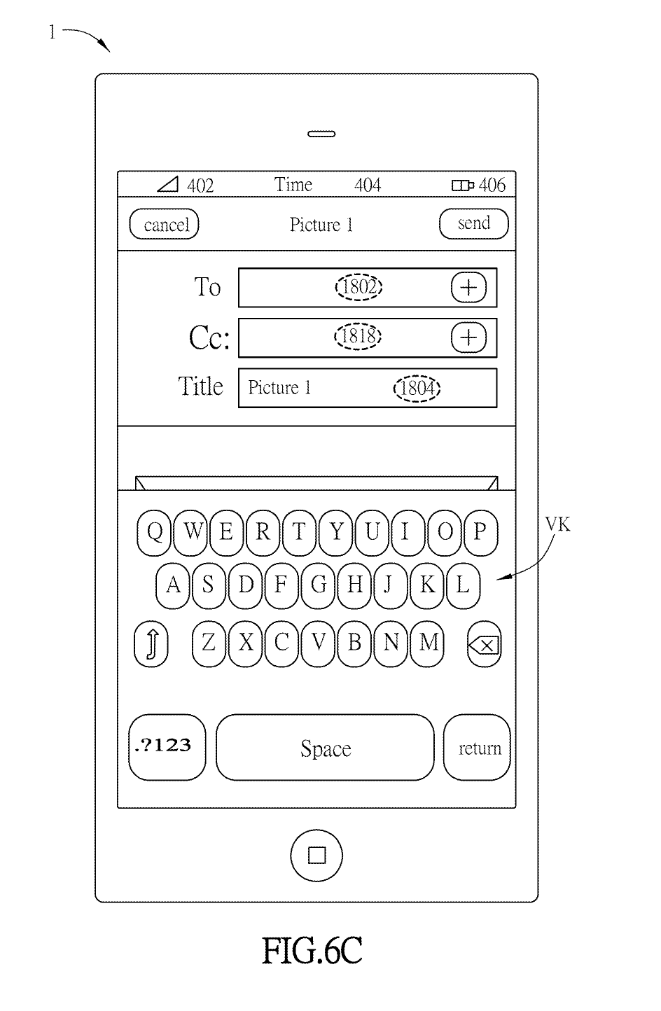

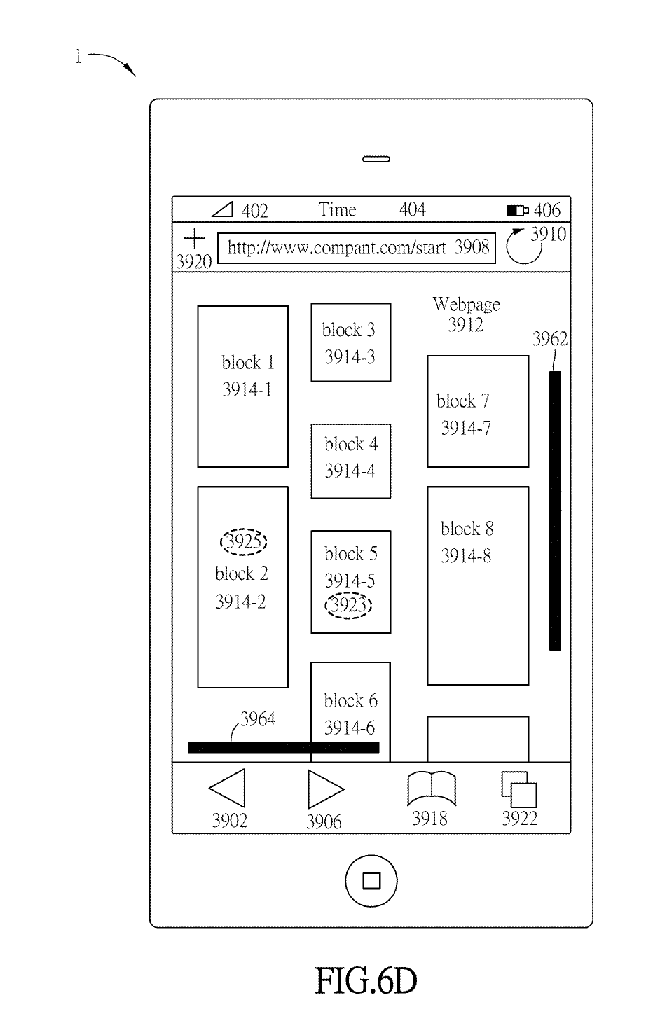

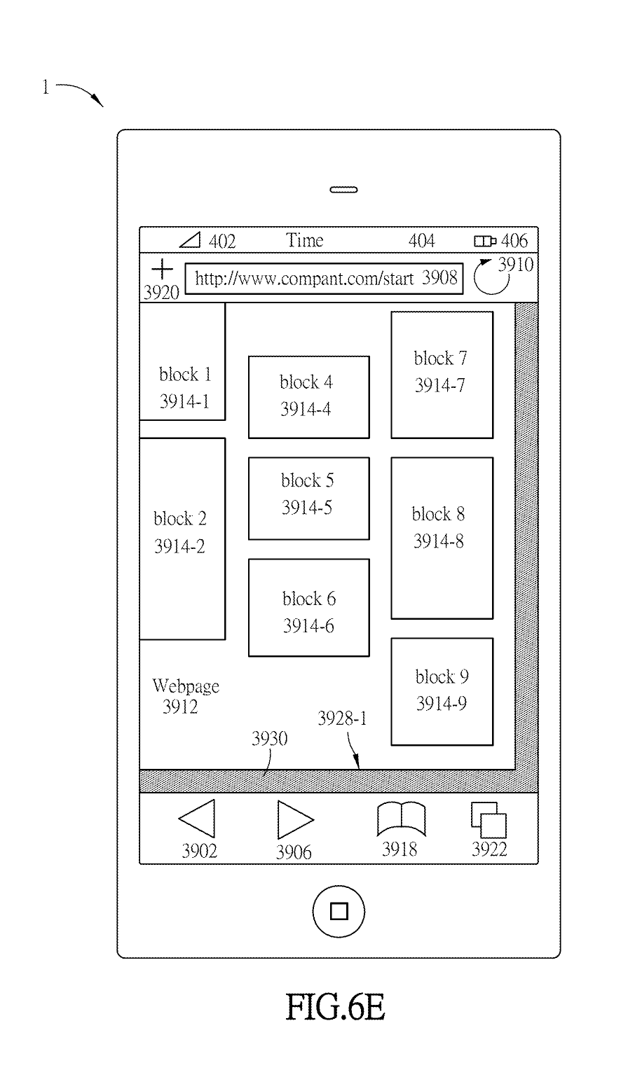

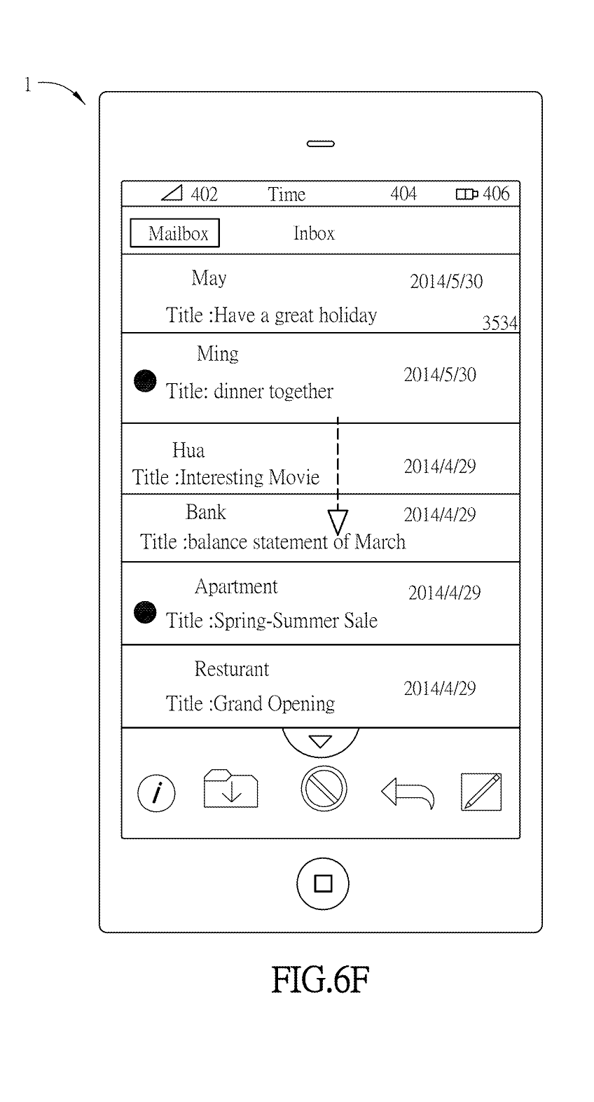

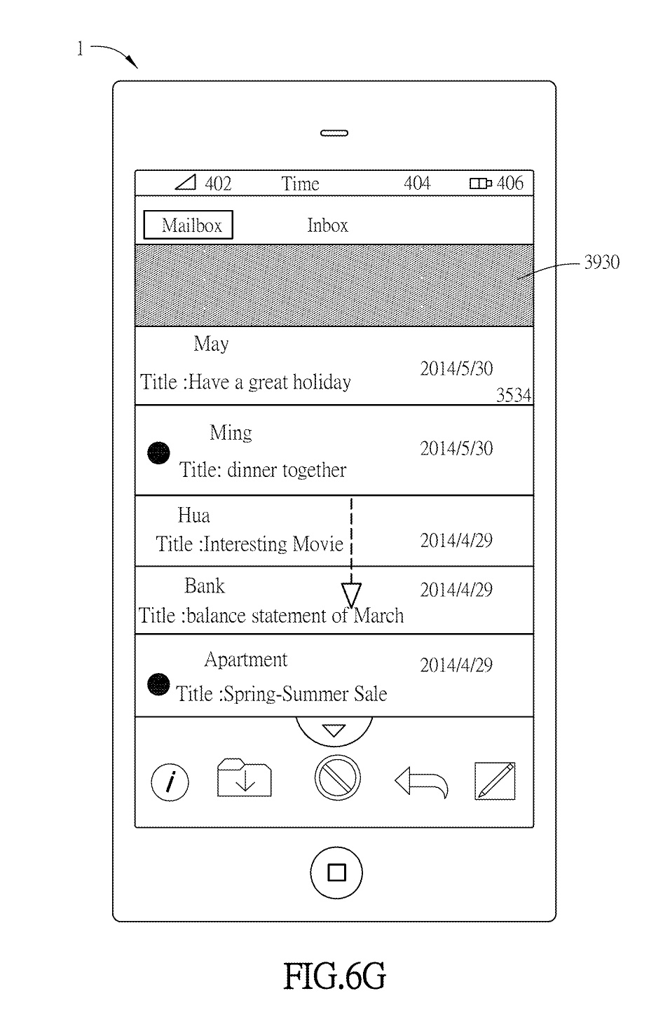

The user interface displayed by the hand-held electronic device 1 will be described as follows. From FIG. 6A to FIG. 6G are schematic diagrams showing different user interfaces of the hand-held electronic device of FIG. 1. FIG. 6A and FIG. 6B are graphical user interfaces for browser and FIG. 6C is a graphical user interface for e-mail. In other embodiments, the graphical user interface can be other display interface, for example, the interface of the multimedia player. Besides, for simplifying drawing, the portion of the hand-held electronic device 1 which the user holds is not displayed.

The graphical user interface displayed on the panel 12 can have one or multiple graph and the user can use one or multiple finger, or stylus to touch the touch-sensing cover 11 to execute the corresponding operation for the graphs displayed on the panel 12. The touch operation can comprise operation gesture or hand gesture, such as a single tap or multiple taps, a single slide or multiple slides (such as a rightward, leftward, upward or downward slide), pinch or stretch. Moreover, the panel 12 can display an arrow or a virtual finger (not shown). When the user operates on the touch-sensing cover 11 such as sliding the finger, the arrow or the virtual finger displayed on the panel 12 can slide correspondingly. Thereby, the graphical user interface displayed on the panel 12 can be directly controlled by the touch-sensing cover 11, and the shadeless touch can be achieved.

In some embodiments, the graphical user interfaces can include, for example but not limited to, the following elements or their subset or the hyperlink of: as shown in FIG. 6A, the signal intensity indicator 402 for the wireless communication; the current time 404; the battery condition indicator 406; the previous page icon 3902, which is activated to display the previous webpage when it is activated; the webpage title 3904; the next page icon 3906, which is activated to display the next webpage when it is activated; the URL (uniform resource locator) input box 3908, which is used to input the URL of the webpage; the refresh icon 3910, which is activated to refresh the webpage when it is activated; the webpage 3912 or another structured document, which is composed of the text content and other graphical blocks 3914 (also called frame, displaying the text or graphical content and including the blocks 3914˜13914-6); the setting icon 3916, which is activated to display the setting menu of the browser; the bookmark icon 3918, which is activated to display the bookmark setting menu of the browser; the bookmark adding icon 3920, which is activated to display the graphical user interface for adding the bookmark; the new window icon 3922, which is activated to start the graphical user interface for adding a new window to the browser. In addition to the above illustrated icons, there may be other icons shown to represent other operational functions, and there may be different icons in the different graphical user interfaces.

In some embodiments, the user can perform an input action on the touch-sensing cover 11 corresponding to the panel 12 by one finger. For example, a screen enlarging operation is executed on the panel 12 by single tap or double taps gesture. For example in FIG. 6A, the block 3914-5 is enlarged and centered (or substantially centered) on the webpage by the gesture 3923. In some embodiments, a one-click gesture or a double-click gesture by one finger is configured to enlarge the screen at a predetermined ratio, for example to enlarge to fit the entire screen.

In some embodiments, the user can perform an input action on the touch-sensing cover 11 corresponding to the panel 12 by one finger or multiple finger contact, for example a single slide or multiple slides, so that an screen scrolling in one dimension is executed on the panel 12. The screen scrolling in one dimension comprises a horizontal scrolling and a vertical scrolling. For example, in FIG. 6B, the gesture 3937 can be utilized to scroll the screen vertically, or the gesture 3939 can be utilized to scroll the screen horizontally. In addition, the vertical scrolling comprises an upward scrolling and a downward scrolling, and the horizontal scrolling comprises a leftward scrolling and a rightward scrolling. In some embodiments, the gesture for the horizontal scrolling within an angle of 27 degree between the horizontal line and the sliding path can be determined as a horizontal scrolling. In some embodiments, the gesture for the vertical scrolling within an angle of 27 degree between the vertical line and the sliding path can be determined as a vertical scrolling.

In some embodiments, the screen scrolling in one dimension can comprise a full screen scrolling or a partial screen scrolling. For example, the full screen scrolling can be defined to change the full screen when the gesture of the input action is finished. For example, the partial screen scrolling can be defined to divide the screen into a plurality of areas and to scroll the partial screen at one area to which the gesture of the input action correspond.

In some embodiments, for example, the partial screen scrolling can also be defined as to show a previous content before scrolling on one part of panel 12 and shows an updated content after scrolling on another part of panel 12 when the gesture of input action is finished. Taking upward scrolling as an example, the content shown on the panel 12 is gradually updated from bottom to top. The previous content at the upper portion is pushed out from the screen because the new content is updated and displayed on the screen from bottom to top. When a sliding speed, a sliding time or a sliding distance of the gesture of input action is within a default value, the screen displayed on the panel 12 will not update totally and a part of the previous content before scrolling still remains.

In some embodiments, the user can perform an input action on the touch-sensing cover 11 corresponding to the panel 12 by multiple finger contact. For example, each of the user's fingers slides in different directions, so that a screen rotation operation for 90 degree is executed on the panel 12. For example, in FIG. 6A, the screen is rotated 90 degree by the gestures 3941, 3943.

In some embodiments, the user can perform an input action on the touch-sensing cover 11 corresponding to the panel 12 by multiple finger contact. For example, a screen enlarging operation is executed on the panel 12 by stretch (sliding the user's fingers oppositely). For example, in FIG. 6A, the gestures 3931, 3933 are utilized to enlarge the screen. In some embodiments, the screen can be reduced in size by the input action from the gesture of pinch (closing fingers). In some embodiments, the controller can enlarge or shrink the screen with a predetermined value according to the pinch distance or the stretch distance of the fingers.

In some embodiments, the user can perform an input action on the touch-sensing cover 11 corresponding to the text information displayed on the panel 12 by one finger or multiple fingers. For example, a virtual keyboard can be called and shown on the panel 12 by single tap or double taps. For example, in FIG. 6C, the virtual keyboard VK is called by the gesture 1802, 1818, 1804.

In some embodiment, the electronic data displayed on the panel will be in response to at least one input action. The panel displays the response electronic data. The electronic data will be in response to the input action of the user and display the execution of the response electronic data. For example, if the input action of the user indicates an upward translating, the display range of the electronic data on the screen is adjusted according to the move distance of the input action.

Referring to FIG. 6D and FIG. 6E, it is determined whether the electronic data reaches the edge of the electronic data 3928-1 or not and at least one input action is still detected. The step detects whether the electronic data reaches the bottom or the top of the item list or the text document. If the electronic data reaches the bottom or the top of the item list or the text document, a detection is performed to determine whether the input action of user has stopped. If the input action of the user is still detected, the electronic data continue to be in response to at least one input action, and shows a blanking block 3930 at the excessive area exceeding the edge of the electronic data. The blanking block is located around the virtual boundary of the edge of the electronic data. According to various settings, the blanking block can comprises a black block, a grey block, a white block or a blurred background block.

It is noted that the electronic data will be translated or rolled according to at least one input action. In the embodiment, a speed of translating or rolling the electronic data to the edge of the electronic data relates to the speed of the input action.

Then, the detection continues to determine whether at least one input action exists. When the user stops inputting for example stopping contacting (no detection point is detected) or forming a static contact point (the detection point stops) on the touch-sensing cover, it is determined that the user stops the input action.

If the input action on the touch-sensing cover 11 is still detected, the blanking area 3930 and the edge of electronic data 3928-1 will be still displayed.

When the user stops the input action, the electronic data is reversely moved until the blanking block is not displayed. For example, when the user input a command to move rightward, the electronic data will be moved leftward after the user stops inputting until the excessive area exceeding the edge of the electronic data is not displayed.

Taking FIG. 6D and FIG. 6E as examples, the electronic data in FIG. 6D is a webpage 3912, and the size (the whole text size) of the webpage 3912 is larger than the display screen, so the user can only view a part of webpage 3912 in FIG. 6D, and the user needs to drag and translate on the touch-sensing cover 11 to view the webpage 3912. When the electronic data is translated to the end or the top, the detection of the user's input action such as dragging or translating still can be performed. In the embodiment, dragging the electronic data upward and leftward is detected. The virtual boundary of the electronic data will be displayed on the screen and a blanking block will be formed around the virtual boundary of the electronic data. When stopping the input action by the user is detected, the electronic data can rebound from the boundary of the display screen. The rebounding effect can be as fast as the speed of the user's input action previously or like an elastic ball to bounce quickly until the excessive area exceeding the list end is not displayed.

Similarly, taking FIG. 6F and FIG. 6G as example, the electronic data in the embodiment is one item list for example an e-mail information list. In some embodiments, the item list also can be an information dialogue list, a favorite phone number list, a contact information list, a tag list, an e-mail binder list, an e-mail address list, an address list, etc.

In the embodiment, the item list has a first item 3534 and a last item (not shown). For example, as shown in figure, May's e-mail is the first item 3534 at the top of the e-mail list. As to the electronic data, the list is rolled according to at least one input action when the user input a drop-down action on the touch-sensing cover 11. When the list is rolled to reach the end of e-mail list and the virtual boundary of the edge of electronic data, a blanking area 3930 is displayed. When stopping the input action by the user is detected, the list is reversely rolled (downward) until the top area of the list is not displayed. In some embodiments, if the list is rolled to the list end, the list will be upwardly rolled until the area exceeding the list end is not displayed.

In the hand-held electronic device, the trigger quantity, the trigger quantity distribution, the trigger morphology, the trigger time, the trigger frequency or the trigger location must firstly conform to the initiative determination condition, then the touch-sensing cover is permitted to receive at least one input action from the user correspondingly to scroll the screen in one dimension, to rotate the screen with 90 degree, to display virtual keyboard, to enlarge the screen, to shrink the screen, to perform screen rebound, etc.

It is also noted that if the trigger morphology indicates multiple area contacts, it is determined not to conform to the initiative determination condition. Here, multiple means two or more than two. In the embodiment, “area contact” means that the diameter of a single touch area on the touch-sensing cover 11 which the user contacts or the longest distance from one touch edge to the other touch edge is longer than 7 mm. The above configuration is based on the condition that it is easy to generate the trigger morphology indicating multiple area contacts when the user does not perform touch operation on the hand-held electronic device 1 and he only simply holds the hand-held electronic device 1, and thus such the trigger event is determined not to conform to the initiative determination condition.

In one embodiment, the trigger morphology of the trigger event indicates the position of the single area contact which is used for determination. For example, if the position of the single area contact is located at the upper half of the hand-held electronic device 1, it is determined not to conform to the initiative determination condition. The above configuration is based on the condition that when the user regularly holds the hand-held electronic device 1 and utilizes his finger to perform touch operation on the touch-sensing cover 11, the palm of the user may form a trigger zone of area contact on the lower half of the hand-held electronic device 1, and the trigger zone of area contact is not formed on the upper half. The diameter of the touch region formed on the upper half by the touch-sensing cover 11 and the finger performing the touch operation or the longest distance from one touch edge to the other touch edge is usually not longer than 7 mm. When a single area contact occurs on the upper half of the hand-held electronic device 1, it is very possible that the user does not perform touch operation but for example wipes the cover or merely holds the hand-held electronic device 1 instead. Here, to distinguish between the upper half and the lower half can depend on the center of the cover 111 or the center of the touch-sensing structure 112, it still depends on actual situation when the user operates the hand-held electronic device 1. The portion upper than the center is regarded as the upper half, and the portion lower than the center is regarded as the lower half.

In addition, a touch-sensing cover of a shadeless touch hand-held electronic device is further provided. The shadeless touch hand-held electronic device includes a panel and a control unit. The touch-sensing cover includes a cover and a touch-sensing structure. The cover is disposed on one side of the shadeless touch hand-held electronic device opposite the panel. Partial or total area of the touch-sensing structure is disposed on the cover. The touch-sensing structure is coupling to the control unit. The touch-sensing structure has a plurality of detection points, which can be triggered. The control unit computes the trigger event of the detection points and compares the trigger event with the initiative determination condition pre-stored in the hand-held electronic device. If the trigger event conforms to the initiative determination condition, the touch-sensing structure is permitted to receive at least one input action and executes the operation corresponding to the input action. The operation comprises a screen scrolling in one dimension, a 90 degree screen rotation, displaying virtual keyboard or a screen enlargement or a screen shrinking corresponding to the panel.

Additionally, in some embodiments, the hand-held electronic device 1 further includes a near field communication unit. The near field communication unit has a near field communication chip and an antenna. The near field communication unit is electrically connected to the control unit 13. The antenna can be disposed on the cover 111 or the touch-sensing structure 112, which is not limited thereto. When the user wants to execute the near field communication between the hand-held electronic device 1 and another electronic device, the user can take the hand-held electronic device 1 close to another electronic device having near field communication function to transmit electronic data to or receive electronic data from another electronic device by the antenna and the near field communication chip.

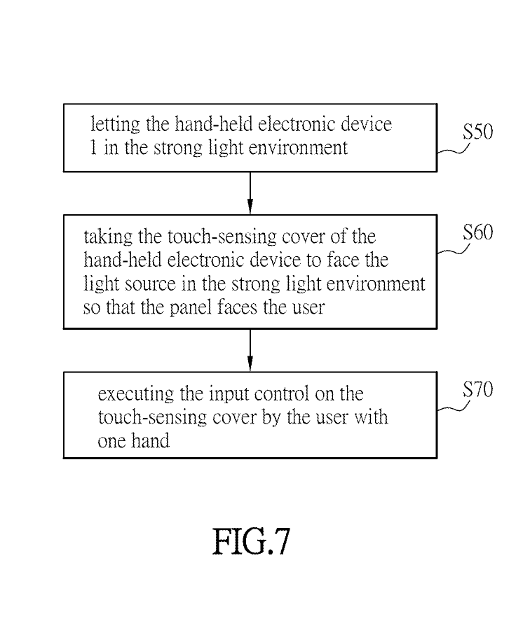

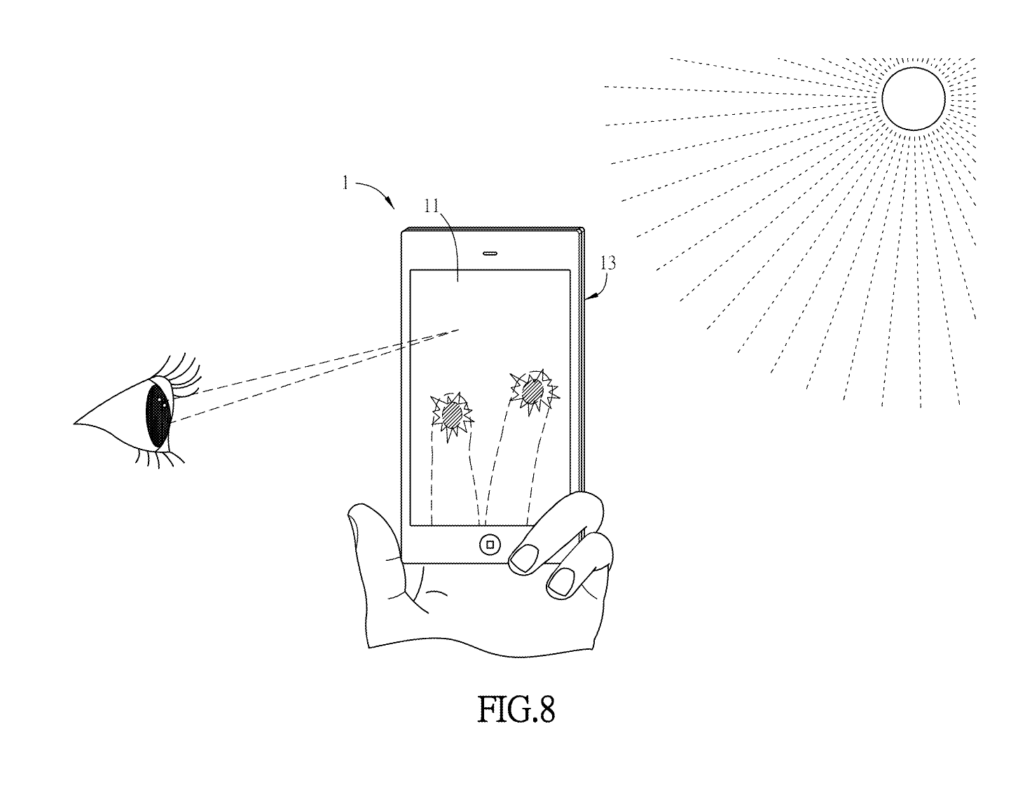

When the user uses the hand-held electronic device 1 in the strong light environment (such as the outdoor sunlight or indoor high-illuminance light), the visibility of the display panel 12 of the hand-held electronic device 1 can be improved according to the method for improving the visibility of the panel 12 of the hand-held electronic device 1 of the embodiment. FIG. 7 is a flow chart showing the method for improving visibility of the display panel 12 of the hand-held electronic device 1 under the strong light according to the embodiment of the invention. FIG. 8 is a schematic diagram showing the hand-held electronic device 1 of FIG. 1 is used under the strong light. Referring to FIG. 7 and FIG. 8, the method for improving the visibility of the panel 12 under the strong light of the embodiment includes following steps: letting the hand-held electronic device 1 in the strong light environment (Step S50); taking the touch-sensing cover 11 of the hand-held electronic device 1 to face the light source in the strong light environment so that the panel 12 faces the user (Step S60); executing the input control on the touch-sensing cover 11 by the user with one hand (Step S70).

In Step S50, the hand-held electronic device 1 is disposed in the strong light environment. The strong light environment includes outdoor and indoor environment. The light source of the strong light environment includes the sun or high-illuminance light. As previously described, the hand-held electronic device 1 includes the touch-sensing cover 11 and the panel 12. The touch-sensing cover 11 is disposed on one side of the hand-held electronic device 1 opposite the panel 12, so the user can operate the hand-held electronic device 1 by one hand and take the touch-sensing cover 11 of the hand-held electronic device 1 to face the light source of the strong light environment so that the panel 12 faces the user can block the sunlight or the light source (Step S60). In FIG. 8, the sunlight is taken as an example. Because the back of the panel 12 faces the light source of the strong light environment, the sunlight visibility of the panel 12 can be enhanced due to blocking of the sunlight by the touch-sensing cover 11. The user can execute the above operation or input control on the touch-sensing cover 11 for the information displayed on the panel 12 by one hand (Step S70). Furthermore, the user can hold the device by one hand and also perform the input operation with the forefinger and/or the middle finger, so as to enhance the single-hand operation performance of the hand-held electronic device 1 under the strong light source (such as the sunlight). Besides, in comparison with the conventional art where just the thumb can be used in the single-hand operation, the operation on the touch-sensing cover by the forefinger or middle finger can provide more flexibility and a novel user experience about the single-hand holding and multi-finger touch operation at the same time.

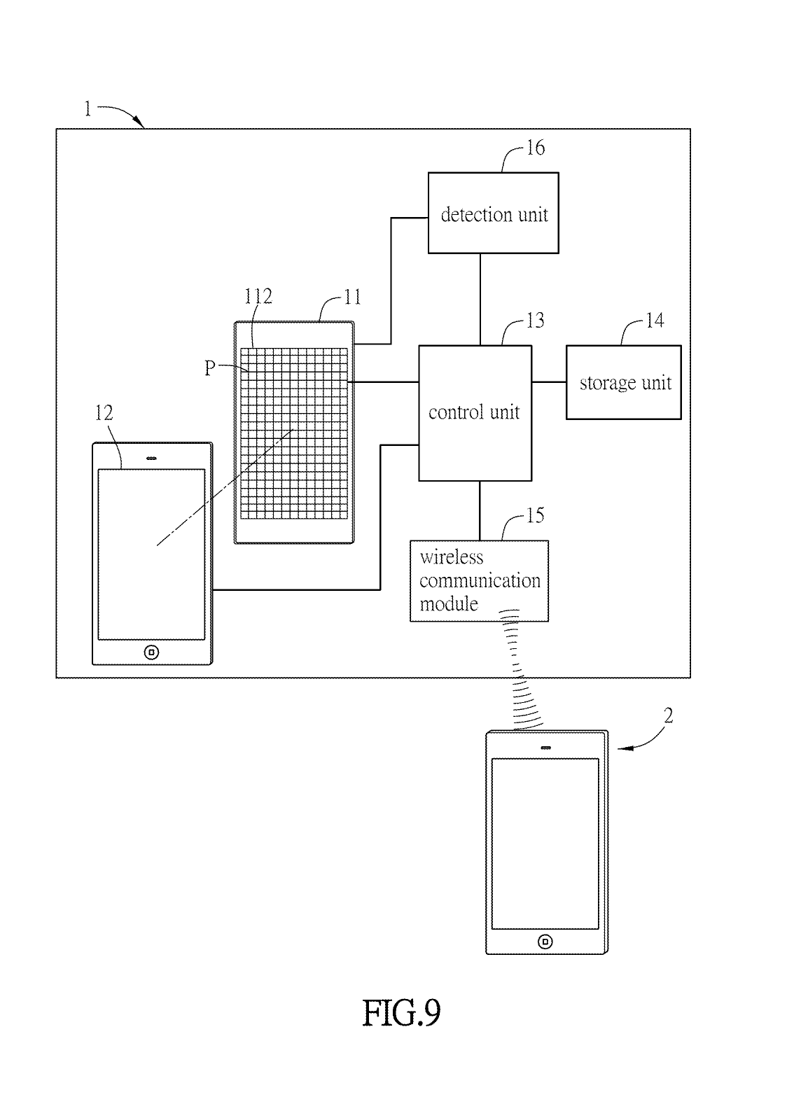

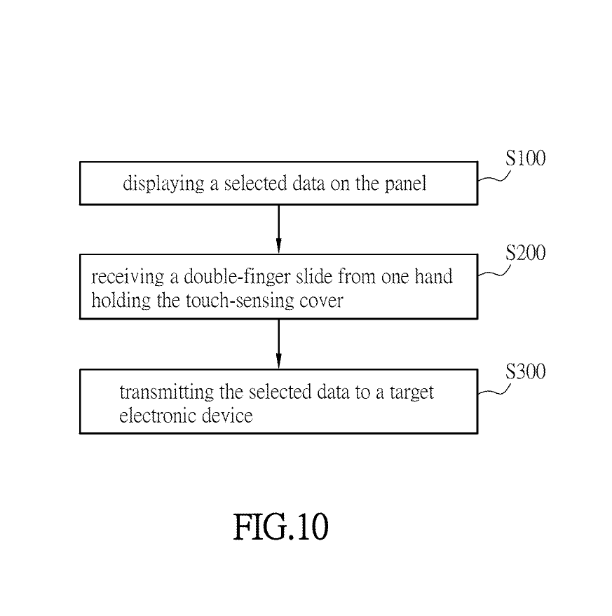

FIG. 9 is a block diagram of the shadeless touch hand-held electronic device according to another embodiment of the invention. FIG. 10 is a flow chart showing the computer-executed method of the embodiment of the invention. The computer-executed method in the embodiment is executed in the hand-held electronic device 1, which includes following steps: displaying a selected data on the panel (Step S100); receiving a double-finger slide from one hand holding the touch-sensing cover (Step S200); and transmitting the selected data to a targeted electronic device (Step S300).

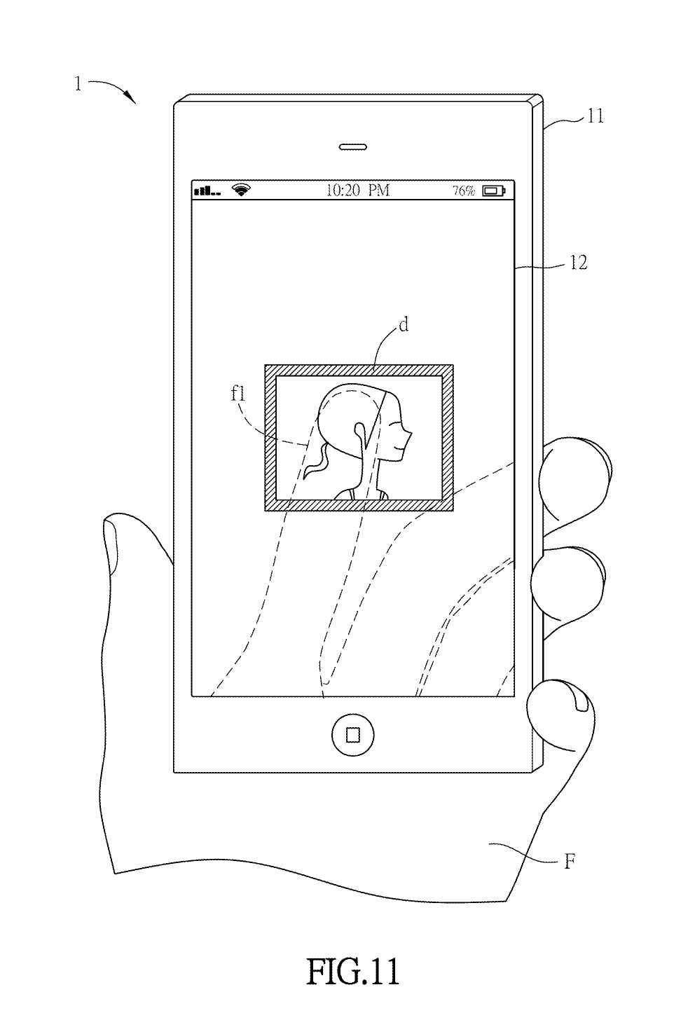

FIG. 11 is a schematic diagram showing the operation of the shadeless hand-held electronic device of FIG. 9. Referring to FIG. 9 and FIG. 11, in the embodiment, the user can transmit the selected data d in hand-held electronic device 1 to a targeted electronic device 2. Herein, the targeted electronic device 2 is similarly a smart phone for example. The targeted electronic device 2 can have the same components and the connection relationships with those of the hand-held electronic device 1. The targeted electronic device 2 can also have components and connection relations different from those of the hand-held electronic device 1. The targeted electronic device 2 may not be a smart phone, which is not limited thereto. The selected data d transmitted to the targeted electronic device 2 can be numerals, texts, image data, audio, video, string data or other digital data. The selected data d in FIG. 11 is a picture stored in the hand-held electronic device 1 for example, which is not limited thereto.

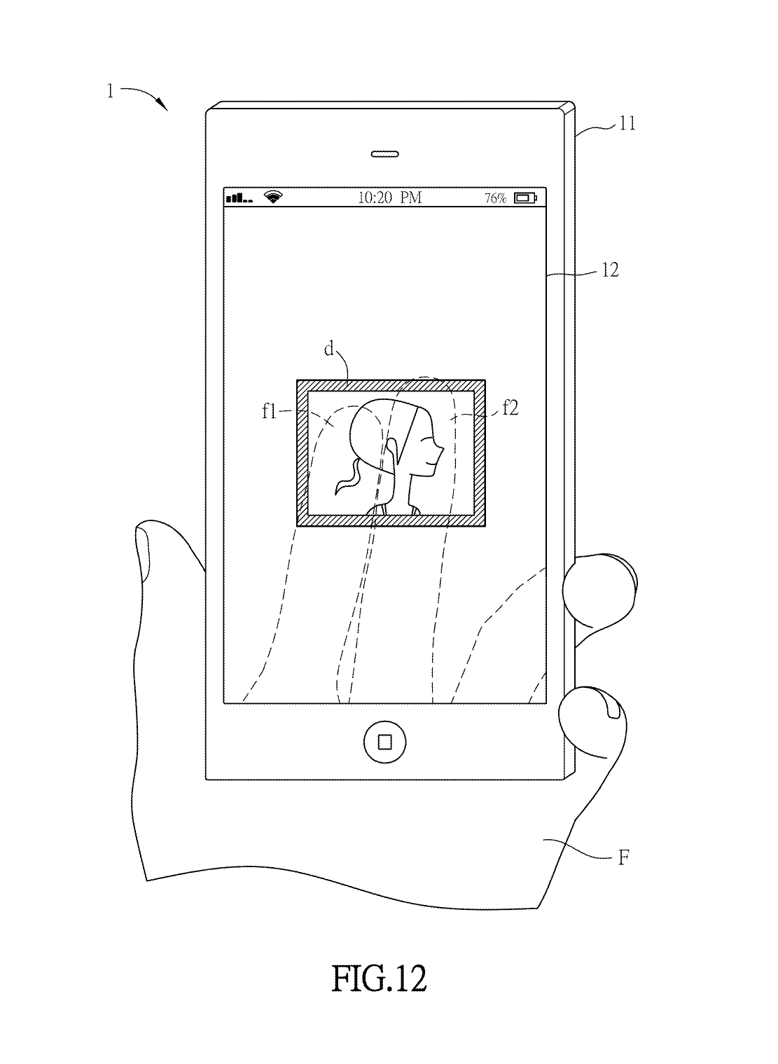

For example, the user can execute an input action on the touch-sensing cover 11 for selecting the data which should be transmitted to the targeted electronic device 2. As shown in FIG. 11, the user holds the hand-held electronic device 1 by one hand F, and utilizes the finger f1 of the hand F to select the picture by clicking on the touch-sensing cover 11, and the selected picture is the selected data d. The selection method in FIG. 11 is called “one-finger selection”. FIG. 12 is an additional schematic diagram showing the operation of the shadeless hand-held electronic device of FIG. 9. The difference from FIG. 11 is that the selection method in FIG. 12 is “double-finger selection”. In detail, the user adopts two fingers f1, f2 of one hand F (especially the forefinger and the middle finger) to select the picture by clicking on the touch-sensing cover, and the selected picture is the selected data d. In some embodiments, the hand-held electronic device 1 can further comprise an eyeball tracking module, such as an eye tracking device, a camera, a video device or an infrared detecting device. The eyeball tracking module can track the eyeball information of the user. Thus, the user can select the data on the panel 12 by the eyeball tracking module, which is not limited thereto.

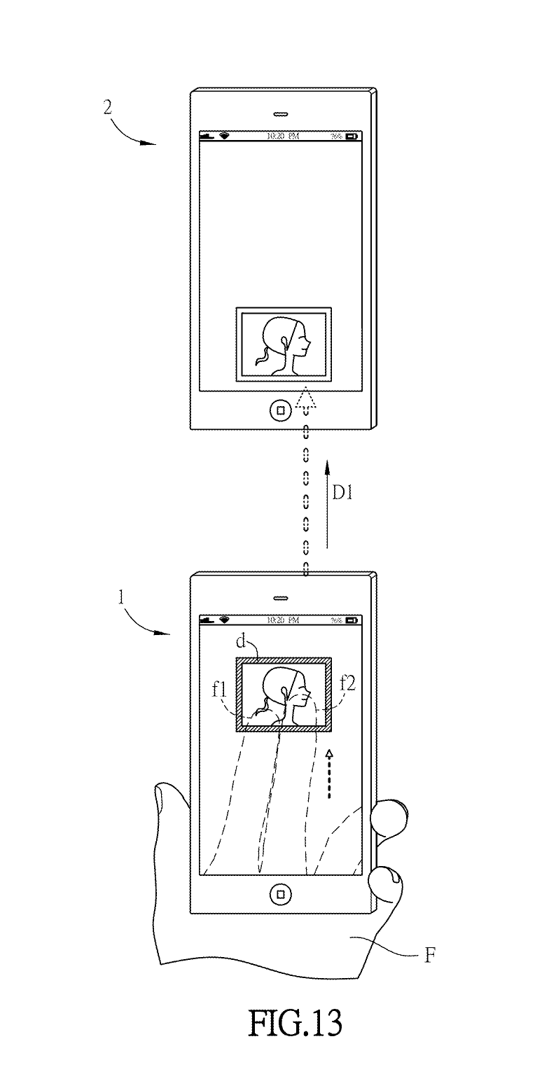

Whether the user uses the method in FIG. 11 or the method in FIG. 12 or other methods to select the data that should be transmitted, the selected data d will be displayed on the panel 12. Then, referring to FIG. 13, FIG. 13 is an additional schematic diagram showing the operation of the shadeless hand-held electronic device of FIG. 9. The user adopts two fingers f1, f2 of one hand F to execute the sliding action (double-finger slide) on the touch-sensing cover 11, so the selected data d can be transmitted to the targeted electronic device 2.

Referring to FIG. 9 and FIG. 13, in some embodiments, the hand-held electronic device 1 can further comprise a wireless communication module 15 electrically connected to the control unit 13. The wireless communication module 15 can comprise an infrared module, a bluetooth module, a zigbee module, a radiofrequency module, or a near field communication module. For example, the targeted electronic device 2 can include an additional wireless communication module corresponding to the wireless communication module 15 of the hand-held electronic device 1. The hand-held electronic device 1 can communicate with the additional wireless communication module of the targeted electronic device 2 by the wireless communication module 15 and transmit the selected data d to the targeted electronic device 2 by the wireless communication module 15. In detail, after the hand-held electronic device 1 establishing connection with the targeted electronic device 2 by the wireless communication module 15, then the control unit 13 will execute the steps in FIG. 10.

In one embodiment, if the wireless communication module 15 of the hand-held electronic device 1 is the near field communication (NFC) module, the near field communication module 15 further includes a user identification key and automatically links the user identification key to the targeted electronic device 2 by the wireless communication module 15 for limiting or controlling the user (who also has the hand-held electronic device 1) on the targeted electronic device 2. In detail, the near communication module has a near communication chip and an antenna. The near field communication chip is electrically connected to the control unit 13 and the antenna can be disposed on the cover 111 or the touch-sensing structure 112, which is not limited thereto. When the user wants to execute the near field communication between the hand-held electronic device 1 and the targeted electronic device 2, the user can take the hand-held electronic device 1 close to the targeted electronic device 2 having near field communication function to transmit electronic data to or receive electronic data from the targeted electronic device 2 by the antenna and the near field communication chip.

Referring FIG. 9, the hand-held electronic device 1 can further include a detection unit 16, which is electrically connected to the control unit 13. The detection unit 16 generates and transmits a transmitting signal to the control unit 13 according to the double-finger slide on the touch-sensing cover 11, and the control unit 13 transmits the selection data to the targeted electronic device according to the transmitting signal.

In one embodiment, the detection unit 16 is further electrically connected to the touch-sensing structure 112. Referring to FIG. 13, the user takes the hand-held electronic device 1 to face the targeted electronic device 2 and uses two fingers f1, f2 of one hand F to execute the double-finger slide on the touch-sensing cover 11 along the direction D1 from the hand-held electronic device 1 to the targeted electronic device 2. Thus, the selected data d can be transmitted from the hand-held electronic device 1 to the targeted electronic device. The detection unit 16 can detect the sliding direction or the sliding angle of the double-finger input action, and generates a transmitting signal according to the sliding direction or the sliding angle. Herein, the sliding direction is defined as the direction toward the targeted electronic device 2 with respect to the hand-held electronic device 1. The sliding angle is defined as the angle toward the targeted electronic device 2 with respect to the hand-held electronic device 1. After receiving the transmitting signal, according to a sliding direction information or a sliding angle information included in the control unit 13, the control unit 13 can transmit the selected data d to the targeted electronic device 2 which the sliding direction information or the sliding angle information corresponds to. In some embodiments, a tolerance of the direction or angle of double-finger slide and a tolerance of the direction or the angle toward the targeted electronic device 2 with respect to the hand-held electronic device 1 are allowable. Namely, if the tolerances of the two are within the tolerance range, the selected data can be permitted to be transmitted from the hand-held electronic device 1 to the targeted electronic device 2.

As mentioned above, as to the shadeless touch hand-held electronic device and touch-sensing cover, the user can perform the touch operation on the touch-sensing cover of the hand-held electronic device, so the user's finger will not shade the view or the object displayed on the panel, and the touch for opening the link of the high information density image will not erroneously execute. Besides, since operating the electronic device is performed on the touch-sensing cover, the panel scratch can be reduced. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can realize a better user experience.

Furthermore, when the user uses the hand-held electronic device under the sun, he can hold the hand-held electronic device just by one hand and use the touch-sensing cover to block the sunlight or light source. Due to the panel information resulting from the touch-sensing cover which blocks the sunlight, the sunlight visibility of the panel is improved, and it can be implemented without advanced OLED or electric paper display panel technique. Furthermore, because the user can hold the device by one hand and perform the operation or input on the touch-sensing cover with respect to the information on the display panel, so as to enhance the single-hand operation performance of the shadeless touch hand-held electronic device under the strong light source.

In addition, the trigger quantity, the trigger quantity distribution, the trigger morphology (which can refer to trigger appearance), the trigger time, the trigger frequency or the trigger location (which can refer to trigger position) must firstly conform to the initiative determination condition, then the hand-held electronic device permits the touch-sensing cover to receive at least one input action from the user and accordingly execute a screen scrolling in one dimension, a 90 degree screen rotation, displaying virtual keyboard, a screen enlargement or a screen shrinking, etc. correspondingly on the panel. Therefore, when other user operates the hand-held electronic device, because the trigger quantity, the trigger quantity distribution, the trigger morphology, the trigger time, the trigger frequency or the trigger location is distinct from the initiative determination condition which is predefined by the origin user, the hand-held electronic device is forbidden to operate so as to enhance the security of the hand-held electronic device for information protection.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device comprising:
a touch-sensing cover, comprising a cover and a touch-sensing structure, wherein partial or total area of the touch-sensing structure is disposed on the cover and has a plurality of detection points;
a panel; and
a control unit, electrically connected to the touch-sensing cover and the panel and executing following steps comprising:
computing a trigger event of the detection points;
comparing the trigger event with an initiative determination condition pre-stored in the shadeless touch hand-held electronic device;
permitting the touch-sensing structure to receive at least one input action from a user if the trigger event conforms to the initiative determination condition; and
executing the operation by the input action.

2. The shadeless touch hand-held electronic device of claim 1, wherein the trigger event comprises a trigger quantity, a trigger quantity distribution, a trigger morphology, a trigger time, a trigger frequency or a trigger location.

3. The shadeless touch hand-held electronic device of claiml, wherein the operation comprises a screen scrolling in one dimension, a screen rotation, a screen enlargement or a screen shrinking correspondingly on the panel.

4. The shadeless touch hand-held electronic device of claim 3, wherein the screen scrolling in one dimension comprises a horizontal scrolling and a vertical scrolling.

5. The shadeless touch hand-held electronic device of claim 1, wherein the operation comprises that the electronic data displayed on the panel is in response to the input action, the panel displays the response electronic data, the electronic data continues in response to the input action and displays a blank block exceeding the edge of the electronic data if the response electronic data reaches the edge of the electronic data and the input action is still detected; the electronic data is reversely moved until the blank block is not displayed if the blank block is detected and at least one of the input action is no longer detected.

6. The shadeless touch hand-held electronic device of claim 5, wherein the electronic data comprises a webpage, an image, a text document, a table, an e-mail or an interface of multimedia player.

7. The shadeless touch hand-held electronic device of claim 1, wherein the control unit computes the trigger event of the detection points with an interval in a predefined time period.

8. The shadeless touch hand-held electronic device of claim 1, wherein the touch-sensing structure comprises metal mesh, metal nanowires, transparent conducting film, carbon nanotube or graphene.

9. The shadeless touch hand-held electronic device of claim 1, wherein the touch-sensing cover is disposed on the side of the shadeless touch hand-held electronic device opposite the panel.

10. The shadeless touch hand-held electronic device of claim 1, further comprising a wireless communication module, wherein the wireless communication module comprises a wireless communication chip and an antenna, the wireless communication chip is electrically connected to the control unit, and the antenna is disposed on the cover or the touch-sensing structure.

11. The shadeless touch hand-held electronic device of claim 1, wherein a circuit board, a battery or a memory card is disposed between the touch-sensing cover and the panel.

12. The shadeless touch hand-held electronic device of claim 1, wherein the user operates the hand-held electronic device by one hand, and takes the touch-sensing cover to face a light source or takes the back of the panel to face the light source.

13. The shadeless touch hand-held electronic device of claim 1, wherein the area of the touch-sensing structure and the area of the panel have a ratio relationship, and the control unit converts an input position into a display position on the panel according to the ratio relationship, and the panel shows a visible sign at the display position.

14. The shadeless touch hand-held electronic device of claim 1, wherein the touch-sensing structure comprises a first sensing layer and a second sensing layer, and at least a part of the first sensing layer or the second sensing layer is capable of a wireless power transmission.

15. A computer-executed method, applied to a shadeless touch hand-held electronic device having a touch-sensing cover, a panel and a control unit, the method executed on the shadeless touch hand-held electronic device comprising:
computing a trigger event of a plurality of detection points of the touch-sensing cover;
comparing the trigger event with an initiative determination condition pre-stored in the shadeless touch hand-held electronic device;
permitting the touch-sensing cover to receive at least one input action from a user if the trigger event conforms to the initiative determination condition; and
executing the operation by the input action.

16. The method of claim 15, wherein the trigger event comprises a trigger quantity, a trigger quantity distribution, a trigger morphology, a trigger time, a trigger frequency or a trigger location.

17. The method of claim 15, wherein the operation comprises a screen scrolling in one dimension, a screen rotation, a screen enlargement or a screen shrinking correspondingly on the panel.

18. The method of claim 17, wherein the operation comprises that the electronic data displayed on the panel is in response to the input action, the panel displays the response electronic data, the electronic data continues in response to the input action and displays a blank block exceeding the edge of the electronic data if the response electronic data reaches the edge of the electronic data and the input action is still detected; the electronic data is reversely moved until the blank block is not displayed if the blank block is detected and at least one of the input action is no longer detected.

19. The method of claim 18, wherein the blank block comprises a black block, a grey block, a white block, or a blurred background block.

20. The method of claim 18, wherein the electronic data comprises a webpage, an image, a text document, a table, an e-mail or an interface of multimedia player.
